(19) United States
(12) Patent Application Publication
(10) Pub. No.: US 2016/0338130 A1
(43) Pub. Date: Nov. 17, 2016

(54) BEARER SETUP METHOD AND APPARATUS IN WIRELESS COMMUNICATION SYSTEM SUPPORTING DUAL CONNECTIVITY

(71) Applicant: LG ELECTRONICS INC., Seoul (KR)

(72) Inventors: Kyungmin PARK, Seoul (KR); Jinsook RYU, Seoul (KR); Jian XU, Seoul (KR); Daewook BYUN, Seoul (KR)

(73) Assignee: LG ELECTRONICS INC., Seoul (KR)

(21) Appl. No.: 15/111,908

(22) PCT Filed: Dec. 29, 2014
(86) PCT No.: PCT/KR2014/012955

§ 371 Date: Jul. 15, 2016

Related U.S. Application Data
(60) Provisional application No. 61/928,415, filed on Jan. 17, 2014.

(51) Int. Cl. H04W 76/02

(52) U.S. Cl. CPC H04W 76/025; H04W 76/021; H04W 76/022; H04W 88/08

(57) ABSTRACT

A method and apparatus for setting up a bearer in a wireless communication system supporting dual connectivity is disclosed. The method for setting up a bearer by a base station (BS) in a wireless communication system supporting dual connectivity, includes requesting, by a first BS, a second BS to set up one or more bearers, receiving, by the first BS, a second bearer list of one or more bearers that can be set by the BS and tunnel end point identifiers (TEIDs) of the bearers included in the second bearer list from the second BS, and transmitting, by the first BS, the second bearer list and the TEIDs of the bearers included in the second bearer list to a mobility management entity (MME).

### TECHNICAL FIELD

The present invention relates to a wireless communication system and, more particularly, to a method and apparatus for setting up a bearer in a wireless communication system supporting dual connectivity.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

Requirements of a next-generation mobile communication system may include supporting huge data traffic, a remarkable increase in a transfer rate per user, accommodation of a significantly increased number of connection devices, very low end-to-end latency, high energy efficiency. To this end, various techniques such as small cell enhancement, dual connectivity, massive multiple input multiple output (MIMO), in-band full duplex, non-orthogonal multiple access (NOMA), supporting super-wide band, device networking, and the like, have been studied.

### DISCLOSURE

### Technical Problem

An object of the present invention is to provide an enhanced network operation efficiently supporting dual connectivity of a user equipment (UE) in a wireless communication system.

Another object of the present invention is to provide a method for effectively setting up an additional bearer to be allocated to a user equipment (UE) in a wireless communication system supporting dual connectivity of a UE.

The technical problems solved by the present invention are not limited to the above technical problems and those skilled in the art may understand other technical problems from the following description.

### Technical Solution

In an aspect of the present invention, a method for setting up a bearer by a base station (BS) in a wireless communication system supporting dual connectivity, includes requesting, by a first BS, a second BS to set up one or more bearers, receiving, by the first BS, a second bearer list of one or more bearers set by the BS and tunnel end point identifier (TEID) of each bearer included in the second bearer list from the second BS, and transmitting, by the first BS, the second bearer list and the TEID of each bearer included in the second bearer list to a mobility management entity (MME).

In another aspect of the present invention, a base station, as a first base station (BS), supporting setup of a bearer in a wireless communication system supporting dual connectivity, includes a radio frequency (RF) unit configured to transmit and receive a radio signal, and a processor, wherein the processor requests a second BS to set up one or more bearers, receives a second bearer list of one or more bearers set up by the second BS and tunnel end point identifier (TEID) of each bearer included in the second bearer list from the second BS, and transmits the second bearer list and the TEID of each bearer included in the second bearer list to a mobility management entity (MME).

Preferably, the method may further includes: receiving, by the first BS, a bearer setup request message from the MME, wherein the first BS requests the second BS to set up one or more bearers requested by the bearer setup request message.

Preferably, the method may further include: determining, by the first BS, whether the first BS is capable to set up one or more bearers which have been refused to be set up by the second BS.

Preferably, the first BS may transmit a first bearer list of bearers set up by the first BS, TEID of each bearer included in the first bearer list, and a third bearer list of one or more bearers which have been refused to be set up by both the first BS and the second BS, together with the second bearer list and the TEID of each bearer included in the second bearer list, to the MME.

Preferably, the first BS may transmit an Internet protocol (IP) address of the second BS, together with the second bearer list and the TEID of each bearer included in the second bearer list, to the MME.

Preferably, the second bearer list and the TEID of each bearer included in the second bearer list are transmitted to the MME through a bearer setup response message.

Preferably, the second bearer list and the TEID of each bearer included in the second bearer list are transmitted to the MME through an E-UTRAN radio access bearer (E-RAB) modification indication message.

### Advantageous Effects

According to embodiments of the present invention, an additional bearer to be allocated to a UE in a wireless communication system supporting dual connectivity of a UE may be effectively set up.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 illustrates a schematic structure a network structure of an evolved universal mobile telecommunication system (E-UMTS) to which the present invention can be applied;

FIG. 2 illustrates architecture of a typical E-UTRAN and a typical EPC to which the present invention can be applied;

FIG. 3 illustrates the configurations of a control plane and a user plane of a radio interface protocol between the E-UTRAN and a UE in the wireless communication system to which the present invention can be applied;

FIG. 4 illustrates the configurations of a control plane and a user plane of an interface protocol between the eNB and the MME in the wireless communication system to which the present invention can be applied;

FIG. 5 is a view illustrating a bearer structure in a wireless communication system to which the present invention can be applied;

FIG. 6 illustrates Dedicated Bearer Activation procedure in the wireless communication system to which the present invention can be applied;

FIG. 7 is a view schematically illustrating a small cell deployment scenario in the wireless communication system to which the present invention can be applied;

FIG. 8 illustrates Control Plane for Dual Connectivity in the wireless communication system to which the present invention can be applied;

FIG. 9 illustrates User Plane architecture for Dual Connectivity in the wireless communication system to which the present invention can be applied;

FIG. 10 illustrates architecture of radio interface protocol for Dual Connectivity between the Network and a UE in the wireless communication system to which the present invention can be applied;

FIG. 11 illustrates Control plane architecture for Dual Connectivity in the wireless communication system to which the present invention can be applied;

FIG. 12 illustrates SeNB Addition procedure in the wireless communication system to which the present invention can be applied;

FIG. 13 illustrates MeNB initiated SeNB Modification procedure in the wireless communication system to which the present invention can be applied;

FIG. 14 illustrates SeNB initiated SeNB Modification procedure in the wireless communication system to which the present invention can be applied;

FIG. 15 is a view illustrating a user plane architecture for dual connectivity in a wireless communication system to which the present invention can be applied;

FIG. 16 is a view illustrating a bearer setup method according to an embodiment of the present invention;

FIG. 17 is a view illustrating a bearer setup method according to an embodiment of the present invention; and

FIG. 18 is a block diagram of a wireless communication apparatus according to an embodiment of the present invention.

### BEST MODE

Reference will now be made in detail to the preferred embodiments of the present invention, examples of which are illustrated in the accompanying drawings. The detailed description set forth below in connection with the appended drawings is a description of exemplary embodiments and is not intended to represent the only embodiments through which the concepts explained in these embodiments can be practiced. The detailed description includes details for the purpose of providing an understanding of the present invention. However, it will be apparent to those skilled in the art that these teachings may be implemented and practiced without these specific details.

In some instances, known structures and devices are omitted, or are shown in block diagram form focusing on important features of the structures and devices, so as not to obscure the concept of the present invention.

In the embodiments of the present invention, the enhanced Node B (eNode B or eNB) may be a terminal node of a network, which directly communicates with the terminal. In some cases, a specific operation described as performed by the eNB may be performed by an upper node of the eNB. Namely, it is apparent that, in a network comprised of a plurality of network nodes including an eNB, various operations performed for communication with a terminal may be performed by the eNB, or network nodes other than the eNB. The term ‘eNB’ may be replaced with the term ‘fixed station’, ‘base station (BS)’, ‘Node B’, ‘base transceiver system (BTS),’, ‘access point (AP)’, etc. The term ‘user equipment (UE)’ may be replaced with the term ‘terminal’, ‘mobile station (MS)’, ‘user terminal (UT)’, ‘mobile subscriber station (MSS)’, ‘subscriber station (SS)’, ‘Advanced Mobile Station (AMS)’, ‘Wireless terminal (WT)’, ‘Machine-Type Communication (MTC) device’, ‘Machine-to-Machine (M2M) device’, ‘Device-to-Device(D2D) device’, wireless device, etc.

In the embodiments of the present invention, “downlink (DL)” refers to communication from the eNB to the UE, and “uplink (UL)” refers to communication from the UE to the eNB. In the downlink, transmitter may be a part of eNB, and receiver may be part of UE. In the uplink, transmitter may be a part of UE, and receiver may be part of eNB.

Specific terms used for the embodiments of the present invention are provided to aid in understanding of the present invention. These specific terms may be replaced with other terms within the scope and spirit of the present invention.

The embodiments of the present invention can be supported by standard documents disclosed for at least one of wireless access systems, Institute of Electrical and Electronics Engineers (IEEE) 802, 3^{rd} Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), ‘non-orthogonal multiple access (NOMA)’, etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunication System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE.

For clarity, this application focuses on the 3GPP LTE/LTE-A system. However, the technical features of the present invention are not limited thereto.

General System to Which the Present Invention may be Applied

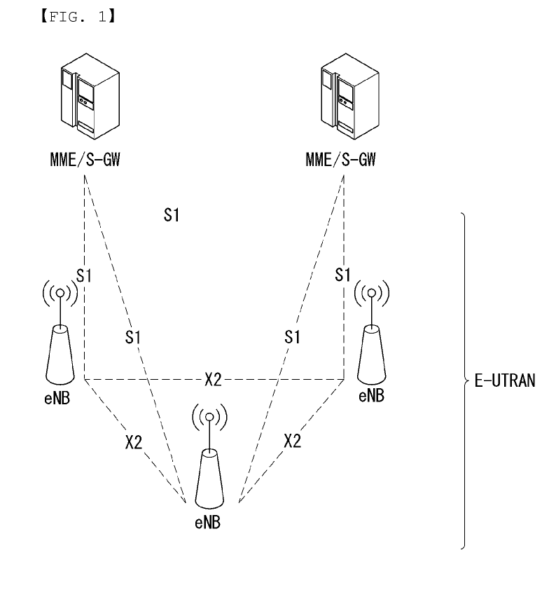

FIG. 1 illustrates a schematic structure a network structure of an evolved universal mobile telecommunication system (E-UMTS) to which the present invention can be applied.

An E-UMTS system is an evolved version of the UMTS system. For example, the E-UMTS may be also referred to as an LTE/LTE-A system. The E-UMTS is also referred to as a Long Term Evolution (LTE) system.

The E-UTRAN consists of eNBs, providing the E-UTRA user plane and control plane protocol terminations towards the UE. The eNBs are interconnected with each other by means of the X2 interface. The X2 user plane interface (X2-U) is defined between eNBs. The X2-U interface provides non guaranteed delivery of user plane packet data units (PDUs). The X2 control plane interface (X2-CP) is defined between two neighbour eNBs. The X2-CP performs following functions: context transfer between eNBs, control of user plane tunnels between source eNB and target eNB, transfer of handover related messages, uplink load management and the like. Each eNB is connected to User Equipments (UEs) through a radio interface and is connected to an Evolved Packet Core (EPC) through an S1 interface. The S1 user plane interface (S1-U) is defined between the eNB and the serving gateway (S-GW). The S1-U interface provides non guaranteed delivery of user plane PDUs between the eNB and the S-GW. The S1 control plane interface (S1-MME) is defined between the eNB and the MME (Mobility Management Entity). The S1 interface performs following functions: EPS (Enhanced Packet System) Bearer Service Management function, NAS (Non-Access Stratum) Signaling Transport function, Network Sharing Function, MME Load balancing Function and the like. The S1 interface supports a many-to-many relation between MMEs/S-GWs and eNBs.

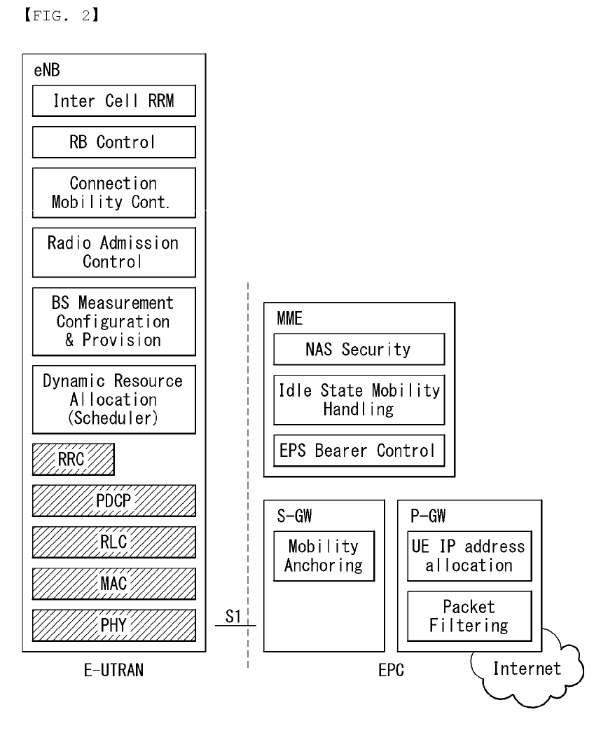

FIG. 2 illustrates architecture of a typical E-UTRAN and a typical EPC to which the present invention can be applied.

Referring to the FIG. 2, the eNB may perform functions of selection for the gateway (for example, MME), routing toward the gateway during a radio resource control (RRC) activation, scheduling and transmitting of paging messages, scheduling and transmitting of broadcast channel (BCH) information, dynamic allocation of resources to the UEs in both uplink and downlink, configuration and provisioning of eNB measurements, radio bearer control, radio admission control (RAC), and connection mobility control in LTE_ACTIVE state. In the EPC, and as stated above, the gateway may perform functions of paging origination, LTE_IDLE state management, ciphering of the user plane, System Architecture Evolution (SAE) bearer control, and ciphering and integrity protection of NAS signaling.

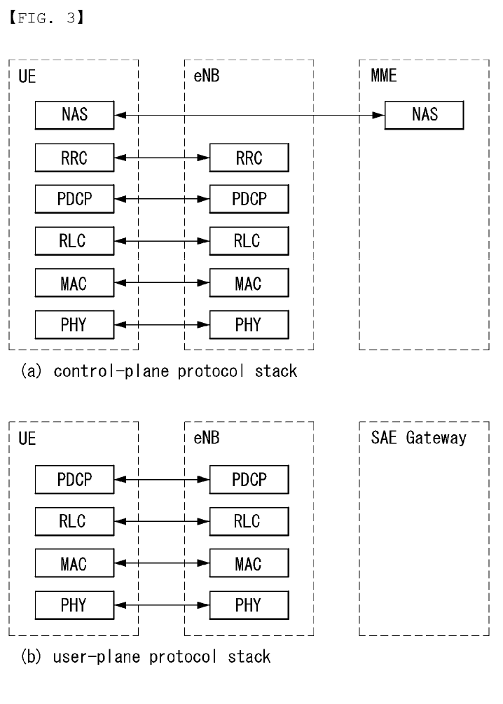

FIG. 3 illustrates the configurations of a control plane and a user plane of a radio interface protocol between the E-UTRAN and a UE in the wireless communication system to which the present invention can be applied.

FIG. 3(a) shows the respective layers of the radio protocol control plane, and FIG. 3(b) shows the respective layers of the radio protocol user plane.

Referring to the FIG. 3, the protocol layers of a radio interface protocol between the E-UTRAN and a UE can be divided into an L1 layer (first layer), an L2 layer (second layer), and an L3 layer (third layer) based on the lower three layers of the Open System Interconnection (OSI) reference model widely known in communication systems. The radio interface protocol is divided horizontally into a physical layer, a data link layer, and a network layer, and vertically into a user plane for data transmission and a control plane for signaling.

The control plane is a passage through which control messages that a UE and a network use in order to manage calls are transmitted. The user plane is a passage through which data (e.g., voice data or Internet packet data) generated at an application layer is transmitted. The following is a detailed description of the layers of the control and user planes in a radio interface protocol.

The physical layer, which is the first layer, provides an information transfer service to an upper layer using a physical channel. The physical layer is connected to a Media Access Control (MAC) layer, located above the physical layer, through a transport channel. Data is transferred between the MAC layer and the physical layer through the transport channel. Data transfer between different physical layers, specifically between the respective physical layers of transmitting and receiving sides, is performed through the physical channel. The physical channel is modulated according to the Orthogonal Frequency Division Multiplexing (OFDM) method, using time and frequencies as radio resources.

The MAC layer of the second layer provides a service to a Radio Link Control (RLC) layer, located above the MAC layer, through a logical channel. The MAC layer plays a role in mapping various logical channels to various transport channels. And, the MAC layer also plays a role as logical channel multiplexing in mapping several logical channels to one transport channel.

The RLC layer of the second layer supports reliable data transmission. The RLC layer performs segmentation and concatenation on data received from an upper layer to play a role in adjusting a size of the data to be suitable for a lower layer to transfer the data to a radio section. And, the RLC layer provides three kinds of RLC modes including a transparent mode (TM), an unacknowledged mode (UM) and an acknowledged mode (AM) to secure various kinds of QoS demanded by each radio bearer (RB). In particular, the AM RLC performs a retransmission function through automatic repeat and request (ARQ) for the reliable data transfer. The functions of the RLC layer may also be implemented through internal functional blocks of the MAC layer. In this case, the RLC layer need not be present.

A packet data convergence protocol (PDCP) layer of the second layer performs a header compression function for reducing a size of an IP packet header containing relatively large and unnecessary control information to efficiently transmit such an IP packet as IPv4 and IPv6 in a radio section having a small bandwidth. This enables a header part of data to carry mandatory information only to play a role in increasing transmission efficiency of the radio section. Moreover, in the LTE/LTE-A system, the PDCP layer performs a security function as well. This consists of ciphering for preventing data interception conducted by a third party and integrity protection for preventing data manipulation conducted by a third party.

A Radio Resource Control (RRC) layer located at the bottom of the third layer is defined only in the control plane and is responsible for control of logical, transport, and physical channels in association with configuration, re-configuration, and release of Radio Bearers (RBs). The RB is a logical path that the second layer provides for data communication between the UE and the E-UTRAN. To accomplish this, the RRC layer of the UE and the RRC layer of the network exchange RRC messages. To Configure of Radio Bearers means that the radio protocol layer and the characteristic of channels are defined for certain service and that each of specific parameters and operating method are configured for certain service. The radio bearer can be divided signaling radio bearer (SRB) and data radio bearer (DRB). The SRB is used as a path for transmission RRC messages in the control plane, and the DRB is used as a path for transmission user data in the user plane.

A Non-Access Stratum (NAS) layer located above the RRC layer performs functions such as session management and mobility management.

One cell of the eNB is set to use a bandwidth such as 1.25, 2.5, 5, 10 or 20 MHz to provide a downlink or uplink transmission service to UEs. Here, different cells may be set to use different bandwidths.

Downlink transport channels for transmission of data from the network to the UE include a Broadcast Channel (BCH) for transmission of system information, a Paging Channel (PCH) for transmission of paging messages, and a downlink Shared Channel (DL-SCH) for transmission of user traffic or control messages. User traffic or control messages of a downlink multicast or broadcast service may be transmitted through DL-SCH and may also be transmitted through a downlink multicast channel (MCH). Uplink transport channels for transmission of data from the UE to the network include a Random Access Channel (RACH) for transmission of initial control messages and an uplink SCH (UL-SCH) for transmission of user traffic or control messages.

Logical channels, which are located above the transport channels and are mapped to the transport channels, include a Broadcast Control Channel (BCCH), a Paging Control Channel (PCCH), a Common Control Channel (CCCH), a dedicated control channel (DCCH), a Multicast Control Channel (MCCH), a dedicated traffic channel (DTCH), and a Multicast Traffic Channel (MTCH).

As an downlink physical channel for transmitting information forwarded on an downlink transport channel to a radio section between a network and a user equipment, there is a physical downlink shared channel (PDSCH) for transmitting information of DL-SCH, a physical control format indicator channel (PDFICH) for indicating the number of OFDM symbols used for transmitting a physical downlink control channel (PDCCH), a physical HARQ (hybrid automatic repeat request) indicator channel (PHICH) for transmitting HARQ ACK (Acknowledge)/NACK (Non-acknowledge) as response to UL transmission or a PDCCH for transmitting such control information, as DL grant indicating resource allocation for transmitting a Paging Channel (PCH) and DL-SCH, information related to HARQ, UL grant indicating resource allocation for transmitting a UL-SCH and like that. As an uplink physical channel for transmitting information forwarded on an uplink transport channel to a radio section between a network and a user equipment, there is a physical uplink shared channel (PUSCH) for transmitting information of UL-SCH, a physical random access channel (PRACH) for transmitting RACH information or a physical uplink control channel (PUCCH) for transmitting such control information, which is provided by first and second layers, as HARQ ACK/NACK (Non-acknowledge), scheduling request (SR), channel quality indicator (CQI) report and the like.

FIG. 4 illustrates the configurations of a control plane and a user plane of an interface protocol between the eNB and the MME in the wireless communication system to which the present invention can be applied.

FIG. 4(a) shows the respective layers of the control plane protocol stack on the S1 interface, and FIG. 4(b) shows the respective layers of the user plane protocol stack on the S1 interface.

The S1 control plane interface (S1-MME) is defined between the eNB and the MME. The transport network layer is built on IP transport, similarly to the user plane but for the reliable transport of signalling messages SCTP is added on top of IP. The application layer signalling protocol is referred to as S1-AP (S1 Application Protocol).

The SCTP layer provides the guaranteed delivery of application layer messages.

In the transport IP layer point-to-point transmission is used to deliver the signalling PDUs.

A single SCTP association per S1-MME interface instance shall be used with one pair of stream identifiers for S1-MME common procedures. Only a few pairs of stream identifiers should be used for S1-MME dedicated procedures. MME communication context identifiers that are assigned by the MME for S1-MME dedicated procedures and eNB communication context identifiers that are assigned by the eNB for S1-MME dedicated procedures shall be used to distinguish UE specific S1-MME signalling transport bearers. The communication context identifiers are conveyed in the respective S1-AP messages.

If the S1 signalling transport layer notifies the S1AP layer that the signalling connection broke:

the MME locally changes the state of the UEs which used this signalling connection to the ECM-IDLE state as described in TS 23.401 [17];

the eNB releases the RRC connection with those UEs.

RNs (Relay Nodes) terminate S1-AP. In this case, there is one S1 interface relation between the RN and the DeNB (Donor eNB), and one S1 interface relation between the DeNB and each of the MMEs in the MME pool. The S1 interface relation between the RN and the DeNB carries non-UE-associated S1-AP signalling between RN and DeNB and UE-associated S1-AP signalling for UEs connected to the RN. The S1 interface relation between the DeNB and an MME carries non-UE-associated S1-AP signalling between DeNB and MME and UE-associated S1-AP signalling for UEs connected to the RN and for UEs connected to the DeNB.

The S1 user plane interface (S1-U) is defined between the eNB and the S-GW. The S1-U interface provides non guaranteed delivery of user plane PDUs between the eNB and the S-GW. The transport network layer is built on IP transport and GTP-U is used on top of UDP/IP to carry the user plane PDUs between the eNB and the S-GW.

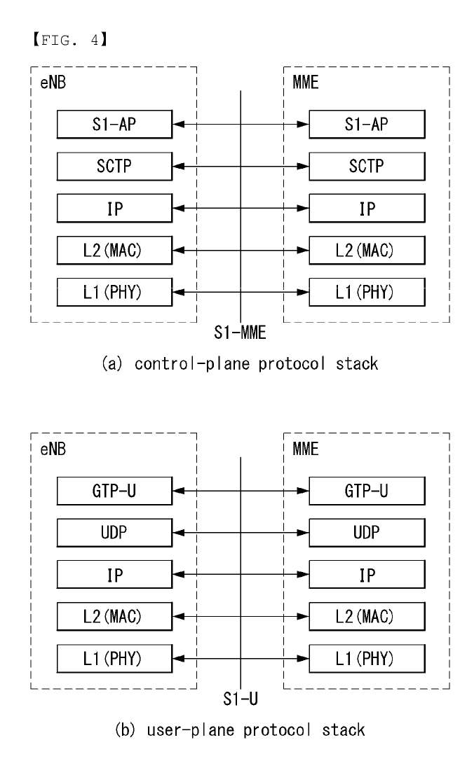

FIG. 5 is a view illustrating a bearer structure in a wireless communication system to which the present invention can be applied.

When a UE is connected to a packet data network (PDN) (the peer entity in FIG. 5), PDN connection is generated. The PDN connection may also be called an EPS session. The PDN, an internet protocol (IP) network outside or within a service provider, provides a service function such as an IP multimedia subsystem (IMS), or the like.

An EPS session has one or more EPS bearers. An EPS bearer is a transmission path of traffic generated between a UE and a packet data network gateway (PDN GW (P-GW)) to deliver user traffic in an EPS. One or more EPS bearers may be set up per UE.

Each EPS bearer may be divided into an E-UTRAN radio access bearer (E-RAB) and an S5/S8 bearer, and an E-RAB may be divided into a radio bearer (RB) and an S1 bearer. Namely, a single EPS bearer corresponds to a single RB, a single S1 bearer, and a single S5/S8 bearer.

The E-RAB delivers a packet of the EPS bearer between a UE and an EPC. When E-RAB exists, an E-RAB bearer and an EPS bearer are mapped in a one-to-one manner. A data radio bearer (DRB) delivers a packet of an EPS bearer between a UE and an eNB. When a DRB exists, the DRB and an EPS bearer/E-RAB are mapped in a one-to-one manner. An S1 bearer delivers a packet of an EPS bearer between an eNB and an S-GW. An S5/S8 bearer delivers an EPS bearer packet between an S-GW and a P-GW.

A UE binds a service data flow (SDF) to an EPS bearer in an uplink direction. A plurality of SDFs, by including a plurality of uplink packet filters, may be multiplexed to the same EPS bearer. In order to bind an SDF and a DRB in uplink, the UE stores mapping between an uplink packet filter and a DRB.

A P-GW binds an SDF to an EPS bearer in a downlink direction. A plurality of SDFs, by including a plurality of downlink packet filters, may be multiplexed to the same EPS bearer. In order to bind an SDF and an S5/S8 bearer in downlink, the P-GW stores mapping between a downlink packet filter and an S5/S8 bearer.

In order to bind a DRB and an S1 bearer in uplink/downlink, the eNB stores a one-to-one mapping between the DRB and the S1 bearer. In order to bind an S1 bearer and an S5/S8 bearer in uplink/downlink, the S-GW stores a one-to-one mapping between the S1 bearer and the S5/S8 bearer.

The EPS bearer is classified into two types of default bearer and dedicated bearer. The UE may have a single default bearer and one or more dedicated bearers per PDN. A minimum basic bearer of an EPS session with respect to a single PDN is called a default bearer.

The EPS bearer may be identified based on an identity. The EPS bearer identity is allocated by a UE or an MME. A dedicated bearer(s) is coupled to a default bearer by a linked EPS bearer identity (LBI).

When a UE initially accesses a network through an initial attach procedure, the UE is allocated an IP address to form a PDN connection, and a default bearer is generated in an EPS section. Even when there is no traffic between the UE and the corresponding PDN, the default bearer is maintained unless the connection between the UE and the PDN is terminated, and when the corresponding PDN is terminated, the default bearer is also released. Here, bearers in every section constituting the default bearer are not activated but an S5 bearer directly connected to the PDN is maintained and an E-RAB bearer (i.e., DRB and S1 bearer) related to radio resource is released. Then, when new traffic is generated in a corresponding PDN, the E-RAB bearer is reset to deliver traffic.

When the UE, while using a service (for example, the Internet, or the like) through the default bearer, uses a service (for example, VoD, or the like) whose QoS is not sufficient only with the default bearer, a dedicated bearer is generated by on-demand. When there is no traffic of the UE, the dedicated bearer is released. The UE or the network may generate a plurality of dedicated bearers as necessary.

An IP flow may have different QoS characteristics depending on a service the UE uses. The network determines a control policy with respect to network resource allocation and QoS when establishing or modifying an EPS session for the UE, and applies the same while the EPS session is maintained. This is called a policy and charging control (PCC). A PCC rule is determined based on operator policies (for example, QoS policy, gate status, billing method, and the like).

The PCC rule is determined by the SDF. The SDF is an IP flow obtained by classifying (or filtering) user traffic by the service or an aggregation of IP flows. That is, IP flows may have different QoS characteristics depending on services the UE uses, and IP flows having the same QoS are mapped to the same SDF and the SDF serves as a unit for applying the PCC rule.

Major entity performing such a PCC function includes a policy and charging control function (PCRF) and a policy and charging enforcement function (PCEF).

The PCRF determines a PCC rule for each SDF when an EPS session is generated or changed, and provides the same to a P-GW (or PCEF). The P-GW sets a PCC rule for corresponding SDFs, detects the SDF for every transmitted/received IP packets, and sequentially applies the PCC rule to the corresponding SDFs. When an SDF is transmitted to the UE, it is mapped to an EPS bearer that provides appropriate QoS according to the QoS rule installed in the P-GW.

The PCC rule may be classified into a dynamic PCC rule and a predefined PCC rule. The dynamic PCC rule is dynamically provided from the PCRF to the P-GW when a EPS session is established or modified. In contrast, the predefined PCC rule, previously set in the P-GW, is activated or deactivated by a PCRF.

An EPS bearer includes a QoS class identifier (QCI) as a basic QoS parameter and an allocation and retention priority (ARP).

The QCI is a scalar used as a reference for accessing node-specific parameters controlling a bearer level packet forwarding treatment, and a scalar value is pre-configured by a network operator. For example, the scalar may be previously set with any one of integer values 1 to 9.

A major object of an ARP is determining whether a request for establishing or modifying a bearer is to be accepted or rejected when resource is limited. Also, the ARP may be used to determine which bearer(s) is to be dropped by an eNB in an exceptional resource limitation (for example, handover, or the like) situation.

The EPS bearer is classified into a guaranteed bit rate (GBR) type bearer and a non-GBR type bearer according to a QCI resource form. A default bearer may always be a non-GBR type bearer, and a dedicated bearer may be a GBR type or non-GBR type bearer. The GBR type bearer may have a GBR and a maximum bit rate (MBR) as QoS parameters in addition to the QCI and the ARP. The MBR refers to that fixed resource is allocated for each bearer (guaranteeing bandwidth). In comparison, the non-GBR type bearer has an aggregated MBR as a QoS parameter in addition to the QCI and the ARP. The AMBR refers to that a maximum bandwidth that may be used together with other non-GBR type bearers is allocated, rather than that resource is not allocated for each bearer.

When QoS of the EPS bearer is determined, QoS of each bearer is determined for each interface. A bearer of each interface provides QoS of the EPS bearer for each interface, and thus, all of the EPS bearer, an RB, an S1 bearer, and the like, have a one-to-one relationship.

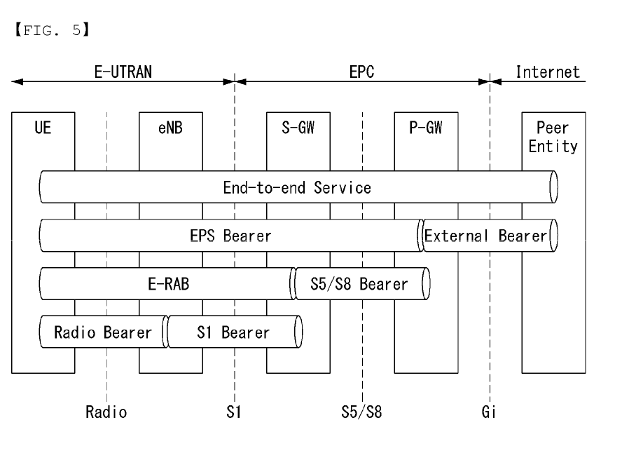

As described above, while using a service through the default bearer, when the UE uses a service whose QoS is not sufficiently satisfied only with the default bearer, a dedicated bearer is generated as on-demand. This will be described in detail with reference to FIG. 6.

FIG. 6 illustrates Dedicated Bearer Activation procedure in the wireless communication system to which the present invention can be applied.

1. If dynamic PCC is deployed, the PCRF sends a PCC decision provision (QoS policy) message to the PDN GW. This corresponds to the initial steps of the PCRF-Initiated IP-CAN (IP Connectivity Access Network) Session Modification procedure or to the PCRF response in the PCEF initiated IP-CAN Session Modification procedure, up to the point that the PDN GW requests IP-CAN Bearer Signalling. The PCC decision provision message may indicate that User Location Information and/or UE Time Zone Information is to be provided to the PCRF. If dynamic PCC is not deployed, the PDN GW may apply local QoS policy.

2. The PDN GW uses this QoS policy to assign the EPS Bearer QoS, i.e., it assigns the values to the bearer level QoS parameters QCI, ARP, GBR and MBR. The PDN GW generates a Charging Id for the dedicated bearer. The PDN GW sends a Create Bearer Request message to the Serving GW. The Create Bearer Request message includes International Mobile Subscriber Identity (IMSI), Procedure Transaction Id (PTI), EPS Bearer QoS, Traffic Flow Template (TFT), S5/S8 Tunnel End Point Identifier (TEID), Charging Id, Linked EPS Bearer Identity (LBI) and Protocol Configuration Options (PCO). The LBI is the EPS Bearer Identity of the default bearer. The PTI parameter is only used when the procedure was initiated by a UE Requested Bearer Resource Modification Procedure. The Protocol Configuration Options may be used to transfer application level parameters between the UE and the PDN GW, and are sent transparently through the MME and the Serving GW. Here, the PCO is sent in the dedicated bearer activation procedure either in response to a PCO received from the UE, or without the need to send a response to a UE provided PCO e.g. when the network wants the bearer to be dedicated for IMS signalling.

3. The Serving GW sends the Create Bearer Request message to the MME. The Create Bearer Request message includes IMSI, PTI, EPS Bearer QoS, TFT, S1-TEID, PDN GW TEID (GTP-based S5/S8), LBI and Protocol Configuration Options. If the UE is in ECM-IDLE state the MME will trigger the Network Triggered Service Request from step 3. In that case the following steps 4-7 may be combined into Network Triggered Service Request procedure or be performed stand-alone.

4. The MME selects an EPS Bearer Identity, which has not yet been assigned to the UE. The MME then builds a Session Management Request including the PTI, TFT, EPS Bearer QoS parameters (excluding ARP), Protocol Configuration Options, the EPS Bearer Identity and the Linked EPS Bearer Identity (LBI). If the UE has UTRAN or GERAN capabilities and the network supports mobility to UTRAN or GERAN, the MME uses the EPS bearer QoS parameters to derive the corresponding PDP context parameters QoS Negotiated (3GPP Release 1999 QoS profile), Radio Priority, Packet Flow Id and Transaction Identifier (TI) and includes them in the Session Management Request. If the UE indicated in the UE Network Capability it does not support Base Station Subsystem (BSS) packet flow procedures, then the MME shall not include the Packet Flow Id. The MME then signals the Bearer Setup Request message to the eNodeB. The Bearer Setup Request message includes EPS Bearer Identity, EPS Bearer QoS, Session Management Request and S1-TEID.

5. The eNodeB maps the EPS Bearer QoS to the Radio Bearer QoS. It then signals a RRC Connection Reconfiguration message to the UE. The RRC Connection Reconfiguration message includes Radio Bearer QoS, Session Management Request and EPS RB Identity. The UE shall store the QoS Negotiated, Radio Priority, Packet Flow Id and TI, which it received in the Session Management Request, for use when accessing via GERAN or UTRAN. The UE NAS stores the EPS Bearer Identity and links the dedicated bearer to the default bearer indicated by the Linked EPS Bearer Identity (LBI). The UE uses the uplink packet filter (UL TFT) to determine the mapping of traffic flows to the radio bearer. The UE may provide the EPS Bearer QoS parameters to the application handling the traffic flow. The application usage of the EPS Bearer QoS is implementation dependent. The UE shall not reject the RRC Connection Reconfiguration on the basis of the EPS Bearer QoS parameters contained in the Session Management Request.

6. The UE acknowledges the radio bearer activation to the eNodeB with a RRC Connection Reconfiguration Complete message.

7. The eNodeB acknowledges the bearer activation to the MME with a Bearer Setup Response message. The Bearer Setup Response message includes EPS Bearer Identity and S1-TEID. The eNodeB indicates whether the requested EPS Bearer QoS could be allocated or not.

The MME shall be prepared to receive this message either before or after the Session Management Response message (sent in step 9).

8. The UE NAS layer builds a Session Management Response including EPS Bearer Identity. The UE then sends a Direct Transfer (Session Management Response) message to the eNodeB.

9. The eNodeB sends an Uplink NAS Transport (Session Management Response) message to the MME.

10. Upon reception of the Bearer Setup Response message in step 7 and the Session Management Response message in step 9, the MME acknowledges the bearer activation to the Serving GW by sending a Create Bearer Response message. The Create Bearer Response message includes EPS Bearer Identity, S1-TEID and User Location Information (ECGI).

11. The Serving GW acknowledges the bearer activation to the PDN GW by sending a Create Bearer Response message. The Create Bearer Response message includes EPS Bearer Identity, S5/S8-TEID and User Location Information (ECGI).

12. If the dedicated bearer activation procedure was triggered by a PCC Decision Provision message from the PCRF, the PDN GW indicates to the PCRF whether the requested PCC decision (QoS policy) could be enforced or not, allowing the completion of the PCRF-Initiated IP-CAN Session Modification procedure or the PCEF initiated IP-CAN Session Modification procedure, after the completion of IP-CAN bearer signalling. If requested by the PCRF the PDN GW indicates User Location Information and/or UE Time Zone Information to the PCRF.

Small Cell Enhancement

In order to accommodate explosively increasing data traffic, research into a small cell enhancement technique to cover a relatively small area using small amount of power, relative to an existing macro cell, has been actively conducted.

Small cell enhancement refers to a technique of densely disposing small cells within macro cell coverage (or without macro cell coverage in case of the interior of a building, or the like) and maximizing spectrum efficiency per unit area through close cooperation between a macro cell eNB and a small cell eNB or between small cell eNBs to enable effective mobility management, while accommodating explosively increasing traffic. In particular, there is huge communication demand in a particular area such as a so-called hot spot within a cell, and receive sensitivity of propagation may be degraded in a particular area such as a cell edge or a coverage hole, and thus, a small cell may be used in a communication shadow area not covered by only a macro cell or an area, such as a hot spot, in which a large amount of data services is requested.

A macro cell eNB may also be called macro eNB (MeNB), and a small cell eNB may also be called small eNB, secondary eNB (SeNB), pico eNB, femto eNB, micro eNB, a remote radio head (RRH), a relay, a repeater, or the like. In this manner, a network in which macro cells and small cells coexist is called a heterogeneous network (HetNet).

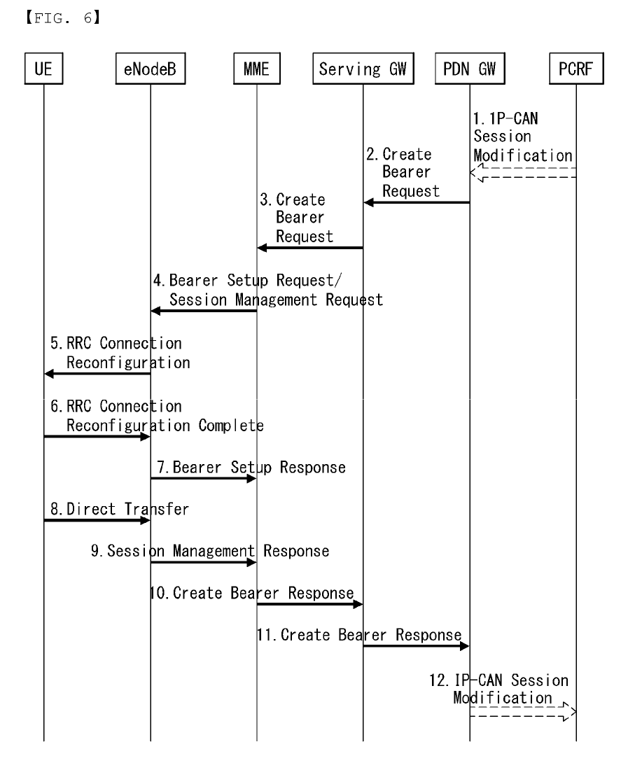

FIG. 7 is a view schematically illustrating a small cell deployment scenario in the wireless communication system to which the present invention can be applied.

Referring to FIG. 7, an MeNB 710 provides a wireless communication environment to a UE within coverage of a macro cell area 711, and an SeNB 720 provides a wireless communication environment to a UE within coverage of a small cell area 721.

As illustrated in FIG. 7, coverage of the macro cell area 711 and coverage of the small cell region 721 may overlap or may not, and a carrier frequency F1 supported by the MeNB 710 and a carrier frequency supported by the SeNB 720 may be identical (when the SeNB supports F1) or may not (when the SeNB supports F2). Both ideal backhaul and non-ideal backhaul may be supported between the MeNB and the SeNB or between a plurality of SeNBs. Also, both a dense or sparse small cell deployment may be considered and both indoor and outdoor small cell deployment may be considered. In FIG. 7, the macro cell area 711 and the small cell area 721 are merely illustrative, and different numbers or sizes of the macro cell areas and the small cell areas may be deployed.

Small cell enhancement considers all of various scenarios as described above with respect to the small cell deployment. This will be described in detail hereinafter.

With and Without Macro Coverage

Small cell enhancement considers both with and without macro coverage. More specifically, Small cell enhancement is considered the deployment scenario in which small cell nodes are deployed under the coverage of one or more than one overlaid E-UTRAN macro-cell layer(s) in order to boost the capacity of already deployed cellular network. Two scenarios can be considered in the deployment scenario with macro coverage, where the UE is in coverage of both the macro cell and the small cell simultaneously and where the UE is not in coverage of both the macro cell and the small cell simultaneously. Also, Small cell enhancement is considered the deployment scenario where small cell nodes are not deployed under the coverage of one or more overlaid E-UTRAN macro-cell layer(s).

Outdoor and Indoor

Small cell enhancement considers both outdoor and indoor small cell deployments. The small cell nodes could be deployed indoors or outdoors, and in either case could provide service to indoor or outdoor UEs. For indoor UE, only low UE speed (i.e., 0-3 km/h) can be considered. On the contrary, for outdoor, not only low UE speed, but also medium UE speed (i.e., up to 30 km/h and potentially higher speeds) should be considered.

Ideal and Non-Ideal Backhaul

Small cell enhancement considers both ideal backhaul (i.e., very high throughput and very low latency backhaul such as dedicated point-to-point connection using optical fiber) and non-ideal backhaul (i.e., typical backhaul widely used in the market such as xDSL, microwave, and other backhauls like relaying). The performance-cost trade-off should be taken into account.

Sparse and Dense

Small cell enhancement considers sparse and dense small cell deployments. In some scenarios (e.g., hotspot indoor/outdoor places, etc.), single or a few small cell node(s) are sparsely deployed, e.g., to cover the hotspot(s). Meanwhile, in some scenarios (e.g., dense urban, large shopping mall, etc.), a lot of small cell nodes are densely deployed to support huge traffic over a relatively wide area covered by the small cell nodes. The coverage of the small cell layer is generally discontinuous between different hotspot areas. Each hotspot area can be covered by a group of small cells, i.e. a small cell cluster.

Synchronization

Both synchronized and un-synchronized scenarios are considered between small cells as well as between small cells and macro cell(s). For specific operations e.g., interference coordination, carrier aggregation (CA) and inter-eNB COMP, small cell enhancement can benefit from synchronized deployments with respect to small cell search/measurements and interference/resource management.

Spectrum

Small cell enhancement addresses the deployment scenario in which different frequency bands are separately assigned to macro layer and small cell layer, respectively. Small cell enhancement can be applicable to all existing and as well as future cellular bands, with special focus on higher frequency bands, e.g., the 3.5 GHz band, to enjoy the more available spectrum and wider bandwidth. Small cell enhancement can also take into account the possibility for frequency bands that, at least locally, are only used for small cell deployments.

Co-channel deployment scenarios between macro layer and small cell layer should be considered as well. Some example spectrum configurations can be considered as follow.

Carrier aggregation on the macro layer with bands X and Y, and only band X on the small cell layer

Small cells supporting carrier aggregation bands that are co-channel with the macro layer

Small cells supporting carrier aggregation bands that are not co-channel with the macro layer.

Small cell enhancement should be supported irrespective of duplex schemes (FDD/TDD) for the frequency bands for macro layer and small cell layer. Air interface and solutions for small cell enhancement should be band-independent.

Traffic

In a small cell deployment, it is likely that the traffic is fluctuating greatly since the number of users per small cell node is typically not so large due to small coverage. In a small cell deployment, it is likely that the user distribution is very fluctuating between the small cell nodes. It is also expected that the traffic could be highly asymmetrical, either downlink or uplink centric. Thus, both uniform and non-uniform traffic load distribution in time-domain and spatial-domain are considered.

Dual Connectivity

In the heterogeneous networks which supports small cell enhancement, there are various requirements related to mobility robustness, increased signalling load due to frequent handover and improving per-user throughput and system capacity, etc.

As a solution to realize these requirements, E-UTRAN supports Dual Connectivity (DC) operation whereby a multiple RX/TX UE in RRC_CONNECTED is configured to utilize radio resources provided by two distinct schedulers, located in two eNBs connected via a non-ideal backhaul over the X2 interface. The Dual connectivity may imply Control and Data separation where, for instance, the control signaling for mobility is provided via the macro cell at the same time as high-speed data connectivity is provided via the small cell. Also, a separation between downlink and uplink, the downlink and uplink connectivity is provided via different cells.

eNBs involved in dual connectivity for a certain UE may assume two different roles, i.e. an eNB may either act as an MeNB or as an SeNB. In dual connectivity a UE can be connected to one MeNB and one SeNB. MeNB is the eNB which terminates at least S1-MME in dual connectivity, and SeNB is the eNB that is providing additional radio resources for the UE but is not the Master eNB in dual connectivity.

In addition, DC with CA configured means mode of operation of a UE in RRC_CONNECTED, configured with a Master Cell Group and a Secondary Cell Group. Here, “cell group” is a group of serving cells associated with either the Master eNB (MeNB) or the Secondary eNB (SeNB) in dual connectivity. “Master Cell Group (MCG)” is a group of serving cells associated with the MeNB, comprising of the primary cell (PCell) and optionally one or more secondary cells (SCells) in dual connectivity. “Secondary Cell Group (SCG)” is a group of serving cells associated with the SeNB comprising of primary SCell (pSCell) and optionally one or more SCells.

Here, the “cell” described herein should be distinguished from a ‘cell’ as a general region covered by a eNB. That is, cell means combination of downlink and optionally uplink resources. The linking between the carrier frequency (i.e. center frequency of the cell) of the downlink resources and the carrier frequency of the uplink resources is indicated in the system information transmitted on the downlink resources.

MCG bearer is radio protocols only located in the MeNB to use MeNB resources only in dual connectivity, and SCG bearer is radio protocols only located in the SeNB to use SeNB resources in dual connectivity. And, Split bearer is radio protocols located in both the MeNB and the SeNB to use both MeNB and SeNB resources in dual connectivity.

FIG. 8 illustrates Control Plane for Dual Connectivity in the wireless communication system to which the present invention can be applied.

Inter-eNB control plane signalling for dual connectivity can be performed by means of X2 interface signalling. Control plane signalling towards the MME is performed by means of S1 interface signalling. There is only one S1-MME connection per UE between the MeNB and the MME. Each eNB should be able to handle UEs independently, i.e. provide the PCell to some UEs while providing SCell(s) for SCG to others. Each eNB involved in dual connectivity for a certain UE owns its radio resources and is primarily responsible for allocating radio resources of its cells, respective coordination between MeNB and SeNB can be performed by means of X2 interface signalling.

Referring to the FIG. 8, the MeNB is C-plane connected to the MME via S1-MME, the MeNB and the SeNB are interconnected via X2-C.

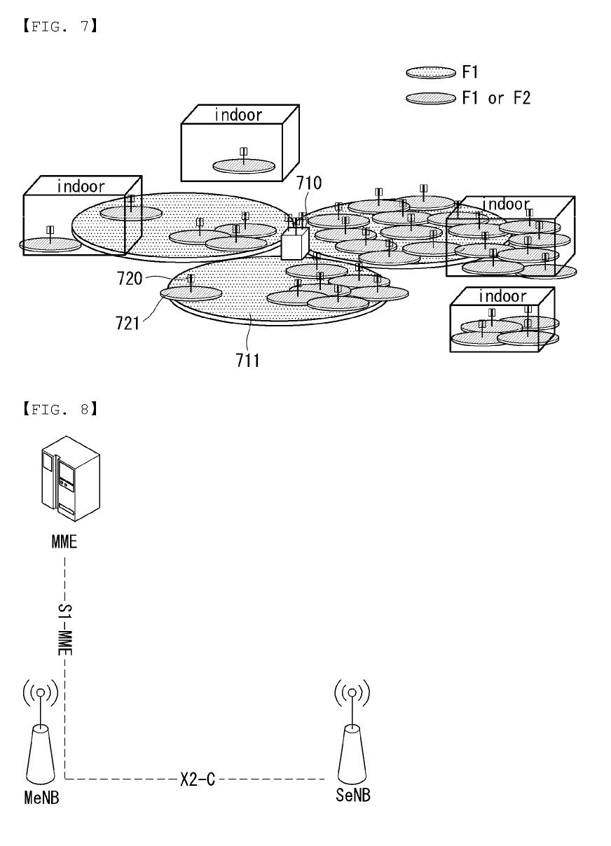

FIG. 9 illustrates User Plane architecture for Dual Connectivity in the wireless communication system to which the present invention can be applied.

FIG. 9 shows U-plane connectivity of eNBs involved in dual connectivity for a certain UE. U-plane connectivity depends on the bearer option configured as follow.

For MCG bearers, the MeNB is U-plane connected to the S-GW via S1-U, the SeNB is not involved in the transport of user plane data. For split bearers, the MeNB is U-plane connected to the S-GW via S1-U and in addition, the MeNB and the SeNB are interconnected via X2-U. Here, split bearer is radio protocols located in both the MeNB and the SeNB to use both MeNB and SeNB resources. For SCG bearers, the SeNB is directly connected with the S-GW via S1-U. Thus, if only MCG and split bearers are configured, there is no S1-U termination in the SeNB.

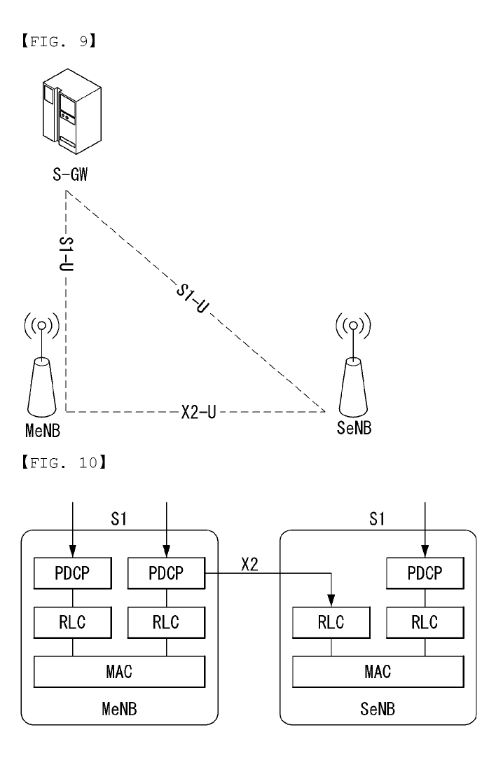

FIG. 10 illustrates architecture of radio interface protocol for Dual Connectivity between the Network and a UE in the wireless communication system to which the present invention can be applied.

In Dual Connectivity, the radio protocol architecture that a particular bearer uses depends on how the bearer is setup. Three alternatives exist, MCG bearer, SCG bearer and split bearer. That is, some bearers (e.g., SCG bearers) of a UE may be served by the SeNB while others (e.g., MCG bearers) are only served by the MeNB. Also, some bearers (e.g., split bearers) of a UE may be split while others (e.g., MCG bearers) are only served by the MeNB. Those three alternatives are depicted on FIG. 10.

In case that MCG bearer and/or SCG bearer is setup, S1-U terminates the currently defined air-interface U-plane protocol stack completely per bearer at a given eNB, and is tailored to realize transmission of one EPS bearer by one node. The transmission of different bearers may still happen simultaneously from the MeNB and a SeNB

In case that split bearer is setup, S1-U terminates in MeNB with the PDCP layer residing in the MeNB always. There is a separate and independent RLC bearer (SAP above RLC), also at UE side, per eNB configured to deliver PDCP PDUs of the PDCP bearer (SAP above PDCP), terminated at the MeNB. The PDCP layer provides PDCP PDU routing for transmission and PDCP PDU reordering for reception for split bearers in DC.

SRBs are always of the MCG bearer and therefore only use the radio resources provided by the MeNB. Here, DC can also be described as having at least one bearer configured to use radio resources provided by the SeNB.

FIG. 11 illustrates Control plane architecture for Dual Connectivity in the wireless communication system to which the present invention can be applied.

Each eNB should be able to handle UEs autonomously, i.e., provide the PCell to some UEs while acting as assisting eNB for other. It is assumed that there will be only one S1-MME Connection per UE.

In dual connectivity operation, the SeNB owns its radio resources and is primarily responsible for allocating radio resources of its cells. Thus, some coordination is still needed between MeNB and SeNB to enable this.

At least the following RRC functions are relevant when considering adding small cell layer to the UE for dual connectivity operation:

Small cell layer's common radio resource configurations

Small cell layer's dedicated radio resource configurations

Measurement and mobility control for small cell layer

In dual connectivity operation, a UE always stays in a single RRC state, i.e., either RRC_CONNECTED or RRC_IDLE.

Referring the FIG. 11, only the MeNB can generate the final RRC messages to be sent towards the UE after the coordination of RRM functions between MeNB and SeNB. The UE RRC entity sees all messages coming only from one entity (in the MeNB) and the UE only replies back to that entity. L2 transport of these messages depends on the chosen UP architecture and the intended solution.

The following general principles can be applied for the operation of dual connectivity.

1) The MeNB maintains the RRM measurement configuration of the UE and may, e.g., based on received measurement reports or traffic conditions or bearer types, decide to ask an SeNB to provide additional resources (serving cells) for a UE.

2) Upon receiving the request from the MeNB, an SeNB may create the container that will result in the configuration of additional serving cells for the UE (or decide that it has no resource available to do so).

3) The MeNB and the SeNB exchange information about UE configuration by means of RRC containers (inter-node messages) carried in Xn messages. Here, the Xn interface can be an X2 interface in LTE/LTE-A system.

4) The SeNB may initiate a reconfiguration of its existing serving cells (e.g., PUCCH towards the SeNB).

5) The MeNB may not change the content of the RRC configuration provided by the SeNB.

Procedure for Dual Connectivity

In order for a UE served by an MeNB to form a dual connection with a different SeNB, a procedure of adding an SeNB may be defined. The procedure of adding an SeNB may be used to request the SeNB to off-load a portion of the bearer set in the MeNB with respect to a UE for which dual connection is not established. Also, when a UE for which dual connection is not established requests adding a bearer so adding of a new bearer is requested by the serving GW, the procedure of adding an SeNB may be used for the MeNB to request setting a bearer for the corresponding UE from the SeNB. Namely, the procedure of adding an SeNB may be used to allocate resource (for example, SCG bearer/split bearer) to the UE from the SeNB to support dual connectivity operation of the UE.

The SeNB Addition procedure is initiated by the MeNB to request the SeNB to allocate resources for dual connectivity operation for a specific UE.

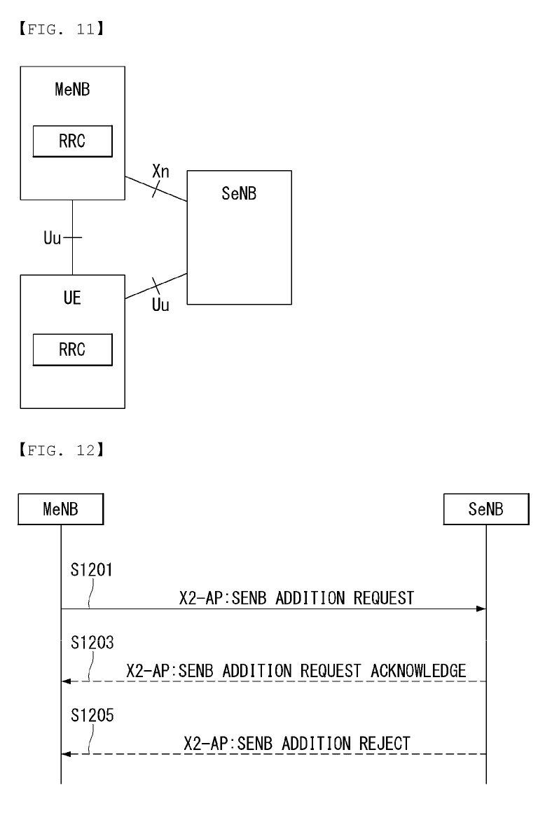

FIG. 12 illustrates SeNB Addition procedure in the wireless communication system to which the present invention can be applied.

Referring to the FIG. 12, the MeNB sends an SENB ADDITION REQUEST message to the SeNB including the bearers for which dual connectivity shall be configured (S1201). SENB ADDITION REQUEST message may include information (for example, E-RAB ID, E-RAB Level QoS Parameters, etc.) regarding a bearer for requesting addition at the SeNB.

In case resource allocation at the SeNB has been performed successfully, the SeNB responds with an SENB ADDITION REQUEST ACKNOWLEDGE message, which includes radio interface related information(e.g., E-RAB ID), successfully established and failed to be established bearers for dual connectivity(S1203).

On the contrary, in case the SeNB addition is not successful (e.g. no resources are available on the SeNB side) the SeNB responds with the SENB ADDITION REJECT message instead of the ADDITION REQUEST ACKNOWLEDGE message (S1205).

In a state in which dual connection of the UE is established, the MeNB or the SeNB may modify resource (for example, SCG bearer/split bearer) allocated to the corresponding UE in order to support dual connectivity operation of the UE at the SeNB in consideration of a load state of each eNB.

The MeNB initiated SeNB Modification procedure is initiated by the MeNB to request the SeNB to modify resources allocated for a specific UE at the SeNB.

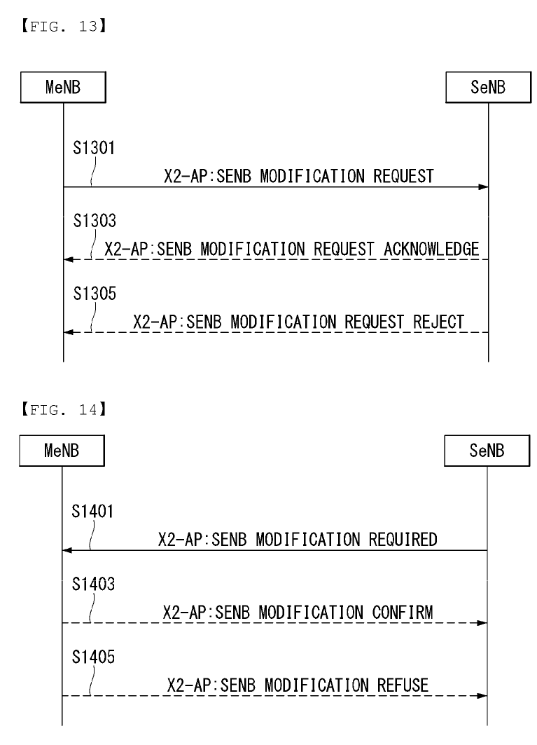

FIG. 13 illustrates MeNB initiated SeNB Modification procedure in the wireless communication system to which the present invention can be applied.

Referring to FIG. 13, the MeNB transmits an SENB MODICATION REQUEST message to the SeNB in order to request modification of resource allocated to the UE at the SeNB based on a load state of the macro cell and the small cell (S1301). When a load of the macro cell is increased or a load of the small cell is reduced, the MeNB may request adding of a new bearer, in addition to the bearer set up in the SeNB. Or, conversely, when a load of the macro cell is reduced or a load of the small cell is increased, the MeNB may request releasing a portion of the bearer set up at the SeNB. The SENB MODICATION REQUEST message may include information regarding a bearer (for example, E-RAB ID, E-RAB Level QoS Parameters, etc.) for requesting modification.

In case resource modification at the SeNB has been performed successfully, the SeNB responds with an SENB MODICATION REQUEST ACKNOWLEDGE message (S1303). SENB MODICATION REQUEST ACKNOWLEDGE message may include information (for example, E-RAB ID) regarding modified bearers and information (for example, E-RAB ID) regarding a modification-failed bearer.

On the contrary, in case the SeNB modification is not successful (e.g. no resources are available on the SeNB side) the SeNB responds with the SENB MODIFICATION REQUEST REJECT message instead of the MODICATION REQUEST ACKNOWLEDGE message (S1305).

The SeNB initiated SeNB Modification Preparation procedure is initiated to request the modification of the UE context at the SeNB.

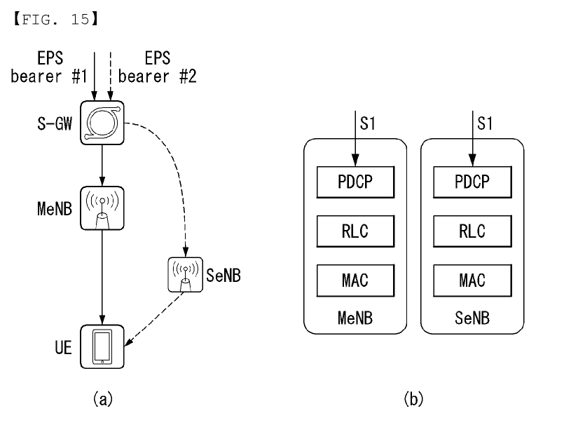

FIG. 14 illustrates SeNB initiated SeNB Modification procedure in the wireless communication system to which the present invention can be applied.

Referring to FIG. 14, in order to request modification of resource allocated to the UE at the SeNB based on load states of the macro cell and the small cell, the SeNB transmits a SENB MODICATION REQUIRED message to the SeNB (S1401). When a load of the macro cell is increased or a load of the small cell is reduced, the SeNB may request addition of a new bearer in addition to the bearer set up at the SeNB. Or, conversely, when a load of the macro cell is reduced or a load of the small cell is increased, the SeNB may request releasing of a portion of the bearers set up at the SeNB. The SENB MODICATION REQUIRED message may include information (for example, E-RAB ID, E-RAB Level QoS Parameters, etc.) regarding a bearer for requesting modification.

In case resource modification at the SeNB has been allowed, the MeNB responds with an SENB MODICATION CONFIRM message (S1403). The SeNB initiated SeNB Modification does not necessarily result in communication towards the UE.

On the contrary, if the MeNB decides to not follow the SeNBs request it replies with a SENB MODIFICATION REFUSE message (S1405).

Bearer Setup for Dual Connectivity System

As described above with reference to FIG. 10, S1-U is terminated in the SeNB as well as in the MeNB in dual connectivity, and the MeNB and the SeNB may have an independent PDCP layer, respectively. This will be described with reference to FIG. 15.

FIG. 15 is a view illustrating a user plane architecture for dual connectivity in a wireless communication system to which the present invention can be applied.

FIG. 15(a) is a view illustrating a flow of data traffic in downlink, and FIG. 15(b) illustrates radio interface protocols.

Referring to FIG. 15(a), since the S1-U is terminated in the SeNB as well as in the MeNB in dual connectivity, a flow of downlink data traffic may be connected to the UE through the MeNB and also connected to the UE through the SeNB. That is, transmission of a single EPS bearer is realized by a single node (namely, MeNB or SeNB). Also, traffic transmission at different bearers may be made simultaneously from the MeNB and the SeNB.

Referring to FIG. 15(b), the MeNB and the SeNB may have an independent PDCP layer, respectively, and thus, a user plane protocol stack per bearer is defined in each of the MeNB and the SeNB.

In FIG. 15, EPS bearer #1 is generated through the MeNB, and EPS bearer #2 is generated through the SeNB. Through the EPS bearer #1, downlink data traffic is transmitted to the UE through the MeNB, and through the EPS bearer #2, the other downlink data traffic is transmitted to the UE through the SeNB. A user plane protocol stack with respect to the EPS bearer #1 is defined in the MeNB, and a user plane protocol stack with respect to the EPS bearer #2 is defined in the SeNB.

The expected benefits are as follow:

no need for MeNB to buffer or process packets for an EPS bearer transmitted by the SeNB;

little or no impact to PDCP/RLC and GTP-U/UDP/IP;

no need to route all traffic to MeNB, low requirements on the backhaul link between MeNB and SeNB and no flow control needed between the two;

support of local break-out and content caching at SeNB straightforward for dual connectivity UEs.

The expected drawbacks are as follow:

SeNB mobility visible to CN;

offloading needs to be performed by MME and cannot be very dynamic;

security impacts due to ciphering being required in both MeNB and SeNB;

utilisation of radio resources across MeNB and SeNB for the same bearer not possible;

for the bearers handled by SeNB, handover-like interruption at SeNB change with forwarding between SeNBs;

in the uplink, logical channel prioritisation impacts for the transmission of uplink data (radio resource allocation is restricted to the eNB where the Radio Bearer terminates).

In a case that the UE has dual connection through the MeNB and the SeNB based on the user plane architecture as described above with reference to FIG. 15, the MeNB congested with heavy traffics may be not able to allow any additional bearer through it. When UE needs additional dedicated bearers, one option to add bearers is that UE adds bearers through MeNB first and then moves them to the path through SeNB. This could be implemented by using the conventional bearer setup procedure, i.e. Dedicated Bearer Activation Procedure in FIG. 6, and the off-loading procedure (or the E-RAB modification procedure between MeNB and SeNB) in FIGS. 12 to 14.

However, those procedures incur inefficiency that E-RAB through MeNB that will be steered to SeNB should be setup first, which may also require the data forwarding procedure toward SeNB. Therefore, in this document, an enhanced method is proposed to make procedures more efficient.

Hereinafter, it is assumed that the UE has dual connection through the MeNB and the SeNB based on the user plane architecture described above with reference to FIG. 15.

Also, in the present disclosure, for the purposes of description, it is assumed that eNB 1 is an MeNB and eNB 2 is an SeNB for the purposes of description. Thus, hereinafter, even without detailed description, an eNB 1 may be understood as an MeNB, and conversely, even without detailed description, an MeNB may be understood as an eNB 1. Similarly, even without a detailed description, an eNB may be understood as an SeNB, and conversely, even without a detailed description, an SeNB may be understood as an eNB 2.

However, application of the present invention is not limited thereto and the present invention may be applied in the same manner even when the eNB 1 is an SeNB and the eNB 2 is an MeNB. Also, the present invention may also be applied in the same manner even when both the eNB 1 and eNB 2 are MeNBs or SeNBs.

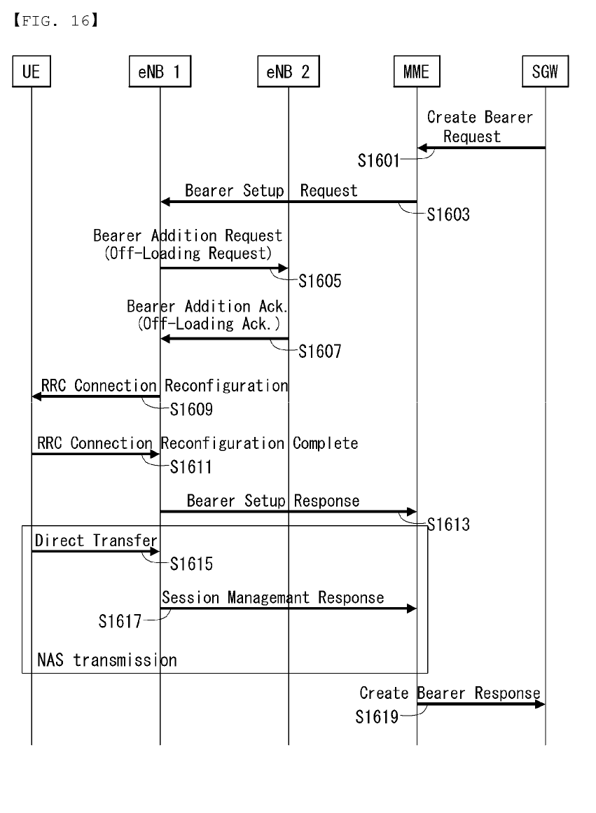

FIG. 16 is a view illustrating a bearer setup method according to an embodiment of the present invention.

FIG. 16 depicts the proposed dedicated bearer activation procedure through eNB 2 in order to reduce the inefficiency that bearers are setup through eNB 1 (e.g., MeNB) and then steered to eNB 2(e.g., SeNB). Operations at the P-GW and the PCRF in the dedicated bearer setup (or activation) process described above with reference to FIG. 6 may be performed in the same manner as that of FIG. 6, and thus, a description thereof will be omitted.

Referring to FIG. 16, the serving GW transmits a Create Bearer Request message to the MME to request creation of bearer (S1601).

Here, the serving GW may request the MME to create one or more bearers requested by the P-GW as illustrated in FIG. 6. The Create Bearer Request message may include IMSI, PTI, EPS Bearer QoS, TFT, S1-TEID, PDN GW TEID (GTP-based S5/S8), LBI or Protocol Configuration Options.

The MME selects an EPS Bearer Identity, which has not yet been assigned to the UE. The MME then builds a Session Management Request including the PTI, TFT, EPS Bearer QoS parameters (excluding ARP), Protocol Configuration Options, the EPS Bearer Identity and the Linked EPS Bearer Identity (LBI). If the UE has UTRAN or GERAN capabilities and the network supports mobility to UTRAN or GERAN, the MME uses the EPS bearer QoS parameters to derive the corresponding PDP context parameters QoS Negotiated (3GPP Release 1999 QoS profile), Radio Priority, Packet Flow Id and Transaction Identifier (TI) and includes them in the Session Management Request. If the UE indicated in the UE Network Capability it does not support Base Station Subsystem (BSS) packet flow procedures, then the MME shall not include the Packet Flow Id.

The MME then signals the Bearer Setup Request message to the eNB 1 (S1603).

Here, the MME may request the eNB 1 to establish (or set up) one or more bearers requested by the serving GW. Bearer Setup Request message may include EPS Bearer Identity of one or more EPS Bearers to be requested, EPS Bearer QoS of one or more EPS Bearers to be requested, Session Management Request or S1-TEID.

eNB 1 asks eNB 2 whether eNB 2 is able to support the bearers requested by MME in the step S1603 (S1605).

That is, in order to request establishment of a bearer requested by the MME, the eNB 1 transmits a Bearer (or SeNB) Addition Request message or Off-Loading Request message to the eNB 2. The Bearer (or SeNB) Addition Request message or the Off-Loading Request message includes a bearer list of one or more bearers for requesting establishment by the eNB 2.

When eNB 1 receives the Bearer Setup Request message from MME, eNB 1 asks eNB 2 whether it is able to support the bearers by MME, instead of establishing bearers on eNB first. Also, when the eNB 1 receives a request for establishment of a plurality of bearers from the MME, the eNB 1 may immediately request the eNB 2 to establish a portion of the plurality of bearers and may establish other bearers by itself.

Also, regardless of whether there is dual connection with respect to a particular UE between the eNB 1 and the eNB 2, the eNB 1 may request the eNB 2 to establish the bearer requested by the MME. If there is no dual connection with respect to a particular UE between the eNB 1 and the eNB 2, the eNB 1 may establish dual connection with respect to the particular UE with the eNB 2 and simultaneously request the eNB 2 to establish the bearer requested by the MME.

eNB 2 responses that it allows all or several bearers of requested bearer lists(S1607). If eNB 2 can ill afford to support any additional bearer, eNB 2 may notify eNB 1 that no bearer is allowed in eNB 2.

That is, the eNB 2 may determine whether it can establish the one or more bearers requested from the eNB 1, and transmits a Bearer (or SeNB) Addition Acknowledge message or Off-Loading Acknowledge message including a bearer list including bearers that can be established by the eNB 2, to the eNB 1.

As described above with reference to FIG. 10, when bearer splitting is applied, downlink data traffic is delivered from the serving GW to the SeNB through the MeNB. In this case, when the MeNB (i.e. eNB 1) establishes the bearer requested by the MME, it generates a destination ID (e.g., TEID) of the bearer and allocates the same to the set bearer.

However, as illustrated above with reference to FIGS. 10 and 15, when the EPS bearer is established in the MeNB and the SeNB, respectively, downlink data traffic is directly delivered from the serving GW to the SeNB without passing through the MeNB. In this case, when the SeNB (i.e. eNB 2) establishes a bearer requested by the MME, the SeNB (i.e. eNB 2) generates a destination ID (e.g., TEID) and allocates the same to the set bearer. Thus, when the SeNB transmits a bearer list regarding a bearer that can be established by the SeNB to the MeNB, the SeNB transmits a destination ID (e.g., TEID) regarding each bearer to the MeNB.

Further, in case that there is no dual connection between MeNB (i.e., eNB 1) and SeNB (i.e. eNB 2), the Bearer (or SeNB) Addition Acknowledge message or the Off-Loading Acknowledge message includes TEID and IP address of SeNB for ERAB that will be setup through SeNB.

The eNB 2 maps EPS bearer QoS supported by the eNB 2 to Radio Bearer QoS allocated in the eNB 2. And, the eNB 2 may transmit RRC configuration information regarding a radio bearer generated by the eNB 2 to the eNB 1 through a Bearer (or SeNB) Addition Acknowledge message or a Off-Loading Acknowledge message. In this case, the RRC configuration information regarding a radio bearer generated by the eNB 2 may be determined in consideration of UE capability or RRC configuration policy of the eNB 1.

When eNB 2 responses that it allows all or several bearers of requested bearer lists, eNB 1 decides whether it establishes the bearers rejected by eNB 2 through itself. eNB 1 decides whether it establishes the bearers rejected by eNB 2 through itself. Then, The eNB 1 maps the EPS Bearer QoS to the Radio Bearer QoS.

eNB 1 transmits an RRC Connection Reconfiguration message including RRC configuration information regarding the bearer established by the eNB 1 and the bearer established by the eNB 2 to the UE (S1609).

The RRC Connection Reconfiguration message may include Radio Bearer QoS, Session Management Request and EPS RB Identity.

The UE shall store the QoS Negotiated, Radio Priority, Packet Flow Id and TI, which it received in the Session Management Request, for use when accessing via GERAN or UTRAN. The UE NAS stores the EPS Bearer Identity and links the dedicated bearer to the default bearer indicated by the Linked EPS Bearer Identity (LBI). The UE uses the uplink packet filter (UL TFT) to determine the mapping of traffic flows to the radio bearer. The UE may provide the EPS Bearer QoS parameters to the application handling the traffic flow. The application usage of the EPS Bearer QoS is implementation dependent. The UE shall not reject the RRC Connection Reconfiguration on the basis of the EPS Bearer QoS parameters contained in the Session Management Request.

The UE acknowledges the radio bearer activation to the eNB 1 with a RRC Connection Reconfiguration Complete message (S1611).

The eNB 1 transmits a Bearer Setup Response message including information regarding the bearers established by the eNB 1 and the eNB 2 to the MME (S1613).

That is, eNB 1 responses to MME that the bearers allowed by eNB 2 will be established through eNB 2, that the bearers that eNB 1 decides to establish through itself will be setup on eNB 1, and that the bearers that neither eNB 2 allows nor eNB 1 accepts to establish are rejected.

As described above, when bearer splitting is applied, only the destination ID (e.g., TEID) regarding the bearer established by the MeNB may be transmitted to the MME. However, in a case in which an EPS bearer is established in the MeNB and the SeNB, respectively, when the MeNB transmits a Bearer Setup Response message to the MME, the MeNB transmits the destination ID(e.g., TEID) regarding the bearer established by the SeNB together.

Further, in case that there is no dual connection between MeNB(i.e. eNB 1) and SeNB(i.e. eNB 2), the Bearer Setup Response message includes TEID and IP address of SeNB for ERAB that will be setup through SeNB.

The UE NAS layer builds a Session Management Response including EPS Bearer Identity. The UE then sends a Direct Transfer (Session Management Response) message to the eNB 1 (S1615).

The eNB 1 sends an Uplink NAS Transport (Session Management Response) message to the MME (S1617).

Upon reception of the Bearer Setup Response message in the step S1613 and the Session Management Response message in the step S1617, the MME acknowledges the bearer activation to the Serving GW by sending a Create Bearer Response message (S1619).

The Create Bearer Response message includes EPS Bearer Identity, S1-TEID and User Location Information (ECGI).

Like the case of FIG. 16, when the MeNB receives a request for generation of a new bearer from the MME, the MeNB may request the SeNB to establish the requested bearer. Also, when a new bearer is established in the SeNB, the MeNB provides information regarding the bearer established in the SeNB to the MME.

However, in addition to the case in which the MME requests the MeNB to generate a new bearer as illustrated in FIG. 16, the MeNB may transmit modification information regarding a bearer established by the SeNB to the MME. For example, an E-RAB Modification Indication procedure may correspond to the case. The E-RAB Modification Indication procedure is initiated by the eNB to support the modification of already established E-RAB configurations. This procedure is used for dual connectivity if the SCG bearer option is applied.

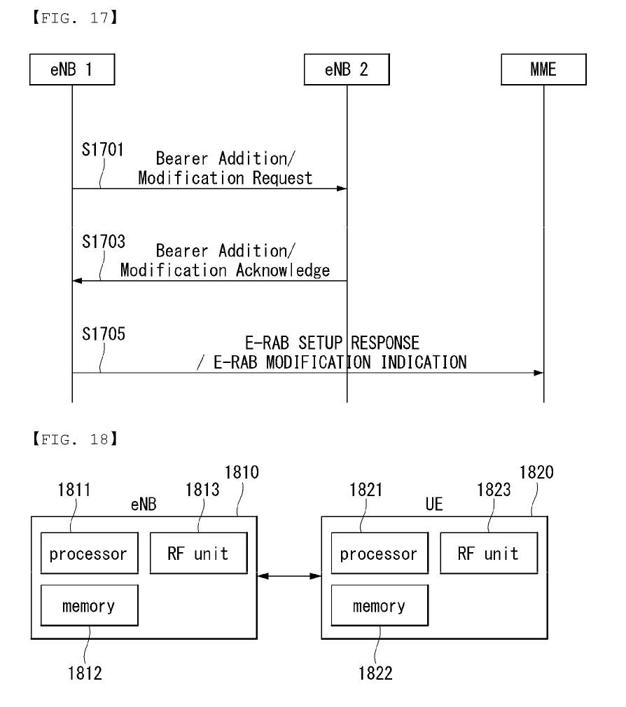

A method of establishing a bearer by the SeNB in the Dedicated Bearer Activation procedure and the E-RAB Modification Indication procedure will be described with reference to FIG. 17.

FIG. 17 is a view illustrating a bearer setup method according to an embodiment of the present invention.

Referring to FIG. 17, in order to request the eNB 2 (e.g., SeNB) to add a bearer, the eNB 1 (e.g., MeNB) transmits a Bearer Addition Request message (or Off-loading Request message), or in order to request modification of a bearer established in the eNB 2, the eNB (e.g., MeNB) transmits a Bearer Modification Request message (S1701).

Here, the Bearer Addition Request message or the Bearer Modification Request message includes a bearer list of one or more bearers established (or set up) in the eNB 2. The eNB 1 may request the eNB 2 to release a bearer established in the eNB 2 through a Bearer Modification Request message, but hereinafter, it is assumed that bearer modification in the eNB 2 is adding a bearer.

First, in a case in which the MME requests the eNB 1 to generate a new bearer as illustrated in FIG. 16, the eNB 1 may transmit a Bearer Addition Request message in order to request the eNB 2 to establish the requested bearer.

Also, in a case in which a load of the eNB 1 is increased, while the eNB 1 is providing a service to the UE through the established bearer, the eNB 1 may request the eNB 2 to establish the bearer established by the eNB 1. For example, a total of three bearers including one default bearer and two dedicated bearers are established by the eNB 1, and while a service is being provided to the UE with the three bearers, the eNB 1 may request the eNB 2 to establish one or more dedicated bearer additionally. In this case, in order to request the eNB 2 to establish a new bearer, the eNB 1 may transmit a Bearer Addition Request message.

On the other hand, in a state in which a bearer is already established between the eNB 1 and the eNB 2 to support dual connectivity of the UE, when a load of the eNB 1 is increased, the eNB 1 may request the eNB 2 to modify an established bearer. For example, in a case in which a total of three bearers including one default bearer and two dedicated bearers are established in the eNB 1 and one dedicated bearer is established in the eNB 2, the eNB 1 may request the eNB 2 to additionally establish one or more dedicated bearer. That is, the eNB 1 may request modification of bearer such that the eNB 2 establish two or more dedicated bearers, rather than one dedicated bearer. In this case, in order to request modification of bearer of the eNB 2, the eNB 1 may transmit a Bearer Modification Request message.

The eNB 2 determines whether it can establish the bearer included in the bearer list requested by the eNB 1, and transmits information regarding a bearer that it can establish on the bearer list requested by the eNB 1, to the eNB 1 (S1703).

When the eNB 2 receives a Bearer Addition Request message, the eNB 2 may transmit a Bearer Addition Acknowledge message (or Off-loading Acknowledge message) in response thereto, and when the eNB 2 receives a Bearer Modification Request message, the eNB 2 may transmit a Bearer Modification Acknowledge message in response thereto. That is, the eNB 2 determines whether it can establish one or more bearers requested (added or modified) by the eNB 1, and transmits a bearer list of bearers that it can establish to the eNB 1.

In this case, if the eNB 2 can ill afford to support any additional bearer, eNB 2 may notify eNB 1 that no bearer is allowed in eNB 2.

As described above with reference to FIGS. 10 and 15, when the EPS bearer is established in the MeNB and the SeNB, respectively, downlink data traffic is directly delivered from the serving GW to the SeNB without passing through the MeNB. In this case, when the SeNB (i.e. eNB 2) establishes a bearer additionally, the SeNB (i.e. eNB 2) generates a destination ID (e.g., TEID) of the added bearer and allocates the same to the corresponding bearer. Also, when the eNB 2 transmits a bearer list regarding a bearer that can be established by the eNB 2 to the eNB 1, the eNB 2 transmits a destination ID (e.g., TEID) regarding each bearer to the eNB 2.

Further, in case that there is no dual connection between MeNB(i.e. eNB 1) and SeNB(i.e. eNB 2), the Bearer Addition Acknowledge message or the Bearer Modification Acknowledge message includes TEID and IP address of SeNB for ERAB that will be setup through SeNB.

The eNB 2 maps EPS bearer QoS supported by the eNB 2 to Radio Bearer QoS allocated by the eNB 2. Also, the eNB 2 may transmit RRC configuration information regarding a radio bearer generated by the eNB 2 to the eNB 1 through a Bearer Addition Acknowledge message or a Bearer Modification Acknowledge message. In this case, the RRC configuration information regarding the radio bearer generated by the eNB 2 may be determined in consideration of UE capability or RRC configuration policy of the eNB 1.

Thereafter, when a new bearer is established in the eNB 2 or when an established bearer is modified in the eNB in S1701 and S1703, the eNB 1 provides information regarding a bearer added or modified in the eNB 2 to the MME (S1705).

When the eNB 1 is requested to generate a new bearer from the MME as illustrated in FIG. 16, the eNB 1 transmits information regarding a bearer established in the eNB 2 through an E-RAB SETUP RESPONSE message.

Meanwhile, when a generation of a new bearer is not requested by the MME, namely, when the eNB 2 is requested to establish a bearer which has been established in the eNB 1 or when a bearer established in the eNB 2 is requested to be modified, the eNB 1 transmits information regarding the bearer established in the eNB 2 to the MME through an E-RAB MODIFICATION INDICATION message.

Here, as the information regarding a bearer established in the eNB 2 transmitted by the eNB 1 to the MME, a bearer list of one or more bearers established in the eNB 2 and a destination ID (e.g., TEID) regarding each bearer may be transmitted.

Further, in case that there is no dual connection between MeNB(i.e. eNB 1) and SeNB(i.e. eNB 2), the Bearer Setup Response message or the E-RAB MODIFICATION INDICATION message includes TEID and IP address of SeNB for ERAB that will be setup through SeNB.

Apparatus for Implementing the Present Invention

FIG. 18 is a block diagram of a wireless communication apparatus according to an embodiment of the present invention.

Referring to FIG. 18, a wireless communication system includes a eNB 1810 and a plurality of UEs 1820 belonging to the eNB 1810. The eNB 1810 include both the aforementioned MeNB and SeNB.

The eNB 1810 includes a processor 1811, a memory 1812, a radio frequency (RF) unit 1813. The processor 1811 may be configured to implement the functions, procedures and/or methods proposed by the present invention as described in FIG. 1-17. Layers of a wireless interface protocol may be implemented by the processor 1811. The memory 1812 is connected to the processor 1811 and stores various types of information for operating the processor 1811. The RF unit 1813 is connected to the processor 1811, transmits and/or receives an RF signal.

The UE 1820 includes a processor 1821, a memory 1822, and an RF unit 1823. The processor 1821 may be configured to implement the functions, procedures and/or methods proposed by the present invention as described in FIG. 1-17. Layers of a wireless interface protocol may be implemented by the processor 1821. The memory 1822 is connected to the processor 1811 and stores information related to operations of the processor 1822. The RF unit 1823 is connected to the processor 1811, transmits and/or receives an RF signal.

The memories 1812 and 1822 may be located inside or outside the processors 1811 and 1821 and may be connected to the processors 1811 and 1821 through various well-known means. The eNB 1810 and/or UE 1820 may include a single antenna or multiple antennas.

The aforementioned embodiments are achieved by combination of structural elements and features of the present invention in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

So far, the example of applying the scheme of setting up a bearer in the wireless communication system supporting dual connectivity according to the present invention to the 3GPP LTE/LTE-A system has been described, but the present invention may be applied to various other wireless communication systems, as well as to the 3GPP LTE/LTE-A system.

1. A method for setting up a bearer by a base station (BS) in a wireless communication system supporting dual connectivity, the method comprising:
requesting, by a first BS, a second BS to set up one or more bearers;
receiving, by the first BS, a second bearer list of one or more bearers set by the second BS and tunnel end point identifier (TEID) of each bearer included in the second bearer list from the second BS; and
transmitting, by the first BS, the second bearer list and the TEID of each bearer included in the second bearer list to a mobility management entity (MME).

2. The method of claim 1, further comprising:
receiving, by the first BS, a bearer setup request message from the MME,
wherein the first BS requests the second BS to set up one or more bearers requested by the bearer setup request message.

3. The method of claim 1, further comprising:
determining, by the first BS, whether the first BS is capable to set up one or more bearers which have been refused to be set up by the second BS.

4. The method of claim 3, wherein the first BS transmits a first bearer list of one or more bearers set up by the first BS, TEID of each bearer included in the first bearer list, and a third bearer list of one or more bearers which have been refused to be set up by both the first BS and the second BS, together with the second bearer list and the TEID of each bearer included in the second bearer list, to the MME.

5. The method of claim 1, wherein the first BS transmits an Internet protocol (IP) address of the second BS, together with the second bearer list and the TEID of each bearer included in the second bearer list, to the MME.

6. The method of claim 1, wherein the second bearer list and the TEID of each bearer included in the second bearer list are transmitted to the MME through a bearer setup response message.

7. The method of claim 1, wherein the second bearer list and the TEID of each bearer included in the second bearer list are transmitted to the MME through an E-UTRAN radio access bearer (E-RAB) modification indication message.

8. A base station, as a first base station (BS), supporting setup of a bearer in a wireless communication system supporting dual connectivity, the BS comprising:
a radio frequency (RF) unit configured to transmit and receive a radio signal; and
a processor,
wherein the processor requests a second BS to set up one or more bearers, receives a second bearer list of one or more bearers set up by the second BS and tunnel end point identifier (TEID) of each bearer included in the second bearer list from the second BS, and transmits the second bearer list and the TEID of each bearer included in the second bearer list to a mobility management entity (MME).
